(19) United States
(12) Patent Application Publication
(10) Pub. No.: US 2026/0041160 A1
(43) Pub. Date: Feb. 12, 2026

(54) AEROSOL GENERATING DEVICE

(71) Applicant: SHENZHEN WOODY VAPES TECHNOLOGY CO., LTD., Shenzhen (CN)

(72) Inventor: Youming LIU, Shenzhen (CN)

(73) Assignee: SHENZHEN WOODY VAPES TECHNOLOGY CO., LTD., Shenzhen (CN)

(21) Appl. No.: 19/072,889

(22) Filed: Mar. 6, 2025

(30) Foreign Application Priority Data
Aug. 8, 2024 (CN) 202411089003.7

(51) Int. Cl. A24F 40/485; A24F 40/57; A24F 40/60; H05B 3/06

(52) U.S. Cl. CPC A24F 40/485; A24F 40/57; A24F 40/60; H05B 3/06; H05B 2203/005; H05B 2203/021

(57) ABSTRACT

An aerosol generating device is provided by the application, and includes a body and an air regulating assembly. An airflow channel is provided in the body and includes an air inlet. The air regulating assembly is movably mounted at the air inlet, and provided with vent holes. The vent holes are different in size. The air regulating assembly is capable of moving relative to the body such that one vent hole communicates with the air inlet. The airflow channel is configured to communicate with an exterior of the body through the vent hole and the air inlet when the vent hole communicates with the air inlet.

### CROSS-REFERENCE TO RELATED APPLICATION

This application claims priority under 35 U.S.C § 119(a) to and the benefit of Chinese Patent Application No.202411089003.7, filed on Aug. 8, 2024, the entire disclosure of which is incorporated herein by reference.

### TECHNICAL FIELD

The present application relates to the technical field of electronic atomization, and more particularly, to an aerosol generating device.

### BACKGROUND

An aerosol generating device is an electronic device capable of atomizing an atomizing liquid into an aerosol for suction by a user. More specifically, an airflow channel is provided in the aerosol generating device, and an atomizer for atomizing the atomizing liquid is provided in the airflow channel. When the aerosol generating device is sucked by the user, external air flows into the airflow channel from an air inlet of the airflow channel, and flows out of an air outlet of the airflow channel and flows into the user's mouth after mixing with the aerosol generated by the atomization at the atomizer.

In the related art, in order to facilitate the user to regulate an air intake amount according to the user's needs, the aerosol generating device is provided with an air regulating mechanism at the air inlet of the airflow channel. The air regulating mechanism can realize the stepless regulation of the air intake amount at the air inlet to meet a user's need.

Some existing aerosol generating devices are provided with different use modes (e.g., a mouth suction mode, a pulmonary suction mode, and the like). Each use mode needs to be adapted to an accurate air intake amount to achieve an optimal experience effect. However, the existing air regulating mechanism is basically stepless regulation, and a user is difficult to enable himself to regulate the device to an accurate position, so that the optimal experience effect in a certain use mode cannot be experienced by the user.

### SUMMARY

An aerosol generating device according to embodiments of the present application includes a body in which an airflow channel is provided, wherein the airflow channel comprises an air inlet; and an air regulating assembly movably mounted at the air inlet, wherein the air regulating assembly is provided with a plurality of vent holes, the plurality of vent holes are different in size, the air regulating assembly is capable of moving relative to the body such that one of the plurality of vent holes communicates with the air inlet; and the airflow channel is configured to communicate with an exterior of the body through the vent hole and the air inlet when the vent hole communicates with the air inlet.

### BRIEF DESCRIPTION OF THE DRAWINGS

In order that the embodiments of the present application or the technical solutions in the prior art may be described more clearly, reference will now be made to the accompanying drawings which are to be used in the description of the embodiments or the prior art. It will be apparent that the accompanying drawings in the description below are merely some of the embodiments of the present application, and that other drawings may be made to those skilled in the art without involving any inventive effort from the structures shown in the accompanying drawings.

FIG. 1 is a sectional view of an aerosol generating device according to embodiments of the present application;

FIG. 2 is an exploded view of a partial structure of an aerosol generating device according to embodiments of the present application;

FIG. 3 is a schematic view of a partial structure of an aerosol generating device according to embodiments of the present application;

FIG. 4 is a structural sectional view of an aerosol generating device at an air inlet thereof according to embodiments of the present application;

FIG. 5 is a bottom view of an air regulating assembly of an aerosol generating device at a first position according to embodiments of the present application;

FIG. 6 is a partial structural sectional view taken along line A-A of FIG. 5;

FIG. 7 is a bottom view of an air regulating assembly of an aerosol generating device at a second position according to embodiments of the present application;

FIG. 8 is a partial structural sectional view taken along line B-B of FIG. 7;

FIG. 9 is a bottom view of an air regulating assembly of the aerosol generating device between a first position and a second position according to embodiments of the present application; and

FIG. 10 is a partial structural sectional view taken along line C-C of FIG. 9.

The realization of the purpose, functional character and advantages of this application will be further described in conjunction with the embodiments with reference to the accompanying drawings.

### DETAILED DESCRIPTION

The technical solution in the embodiments of the present application will be clearly and completely described with reference to the accompanying drawings. It will be apparent that the described embodiments are only some of the embodiments of the present application, and not all embodiments. Based on the embodiments in the present application, all other embodiments obtained by a person skilled in the art without involving any inventive effort are within the scope of the present application.

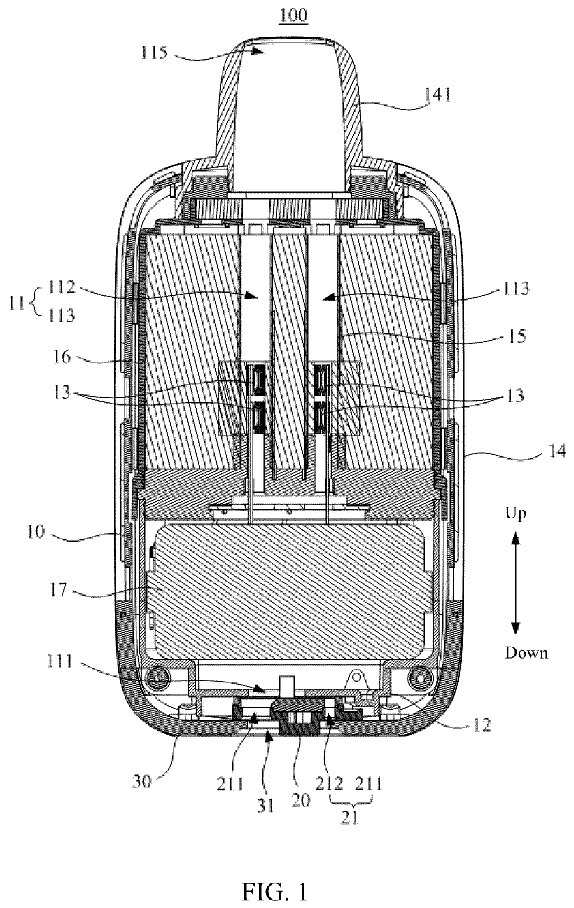

As shown in FIG. 1, in order to solve a problem that an air regulating mechanism of a conventional aerosol generating device cannot perform fine air regulating, in the present application, it is provided an aerosol generating device 100. The aerosol generating device 100 includes a body 10 and an air regulating assembly 20.

As shown in FIG. 1, an airflow channel 11 is provided in the body 10, and the airflow channel 11 includes an air inlet 111. Specifically, in the present embodiment, the body 10 includes a housing 14, an air guide assembly, an atomizing assembly, a liquid supply assembly, and a power supply assembly. The housing 14 provides installation space and protection for other assemblies. The housing 14 is provided with a suction nozzle 141. The air guide assembly includes an air guide tube 15. The air guide tube 15 is mounted in the housing 14. A part of the airflow channel 11 is formed in the air guide tube 15, and other parts of the airflow channel 11 may be formed by gaps between the assemblies. The specific forming manner may be realized according to the related prior art.

A portion of the airflow channel 11 which is at the lower end of the body 10 forms the air inlet 111, and a portion of the airflow channel 11 which is at the suction nozzle 141 forms an air outlet 115. During suction of the user, the air outside the body 10 flows from the air inlet 111 into the airflow channel 11, then flows along the airflow channel 11 to the air outlet 115, and finally flows out from the air outlet 115 and into the user's mouth.

The atomizing assembly is mounted in the airflow channel 11. The atomizing assembly may include heating elements 13, liquid absorbent cotton, electrical conductors. The heating elements 13 are electrically connected to the power supply assembly by electrical conductors, so that the heating elements 13 can be powered on to generate heat. The liquid absorbent cotton is typically sleeved outside the heating element 13, and the liquid absorbent cotton is used to absorb the atomizing liquid from the liquid supply assembly and to direct the atomizing liquid to the heating element 13, so that the heating element 13 in a heating state can atomize the atomizing liquid.

As described above, the liquid supply assembly is mainly used for supplying the atomizing liquid to the atomizing assembly, and may include a liquid cup 16. A liquid storage chamber is provided in the liquid cup 16. The liquid storage chamber stores the atomizing liquid, and a liquid outlet may be provided at a portion of the side wall of the liquid storage chamber which corresponds to the liquid absorbent cotton. So, the liquid absorbent cotton in the atomizing assembly can adsorb the atomizing liquid to the heating elements.

The power supply assembly generally includes a battery 17, and a control board. The control board is electrically connected to the battery 17, and the atomizing assembly is electrically connected to the control board via electrical conductors, so that the atomizing assembly can be controlled to operate or not operate by the control board.

In conclusion, in the present application, the body 10 can realize the basic function of the aerosol generating device 100. Without adding other components, the user can directly suck the body 10. At the time of suck, air outside the body 10 flows into the airflow channel 11 from the air inlet 111 at the lower end of the body 10, while the atomizing assembly atomizes the atomizing liquid into an aerosol. Further, the air flows along the airflow channel 11 to the atomizing assembly and then mixes with the aerosol, then continues to flow to the air outlet 115 along the airflow channel 11, and finally flows out from the air outlet 115 and into the user's mouth.

In the present application, as shown in FIG. 1, the aerosol generating device 100 further includes an air regulating assembly 20 movably mounted at the air inlet 111. The air regulating assembly 20 is provided with a plurality of vent holes 21. The plurality of vent holes 21 are arranged differently in size. The air regulating assembly 20 is capable of moving relative to the body 10, so that one of the vent holes 21 communicates with the air inlet 111. When the vent hole 21 communicates with the air inlet 111, the airflow channel 11 communicates with the outside of the body 10 through the vent hole 21 and the air inlet 111.

Specifically, the specific composition of the air regulating assembly 20 may be flexibly provided according to actual conditions. For example, when the air outlet 115 is located at a lower end of a circumferential side surface of the body 10, the air regulating assembly 20 may include an air regulating ring. The air regulating ring is rotatably sleeved on the circumferential side surface of the body 10. Multiple vent holes 21 are penetrated through the air regulating ring. The air regulating ring is rotated so that any one of the vent holes 21 is in corresponding communication with the air inlet 111.

For another example, when the air outlet 115 is located on the lower end surface of the body 10, the air regulating assembly 20 may include an air regulating rotation disc. The air regulating rotation disc is rotatably mounted on the lower end surface of the body 10. The multiple vent holes 21 are penetrated through the air regulating rotation disc. The air regulating rotation disc is rotated so that any one of the vent holes 21 is in corresponding communication with the air inlet 111.

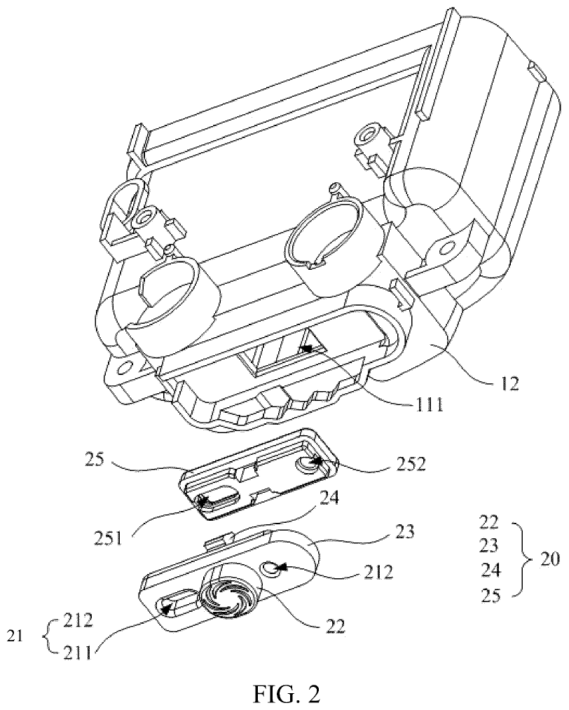

For another example, as shown in FIG. 2 or FIG. 4, when the air outlet 115 is located on the lower end surface of the body 10, the air regulating assembly 20 may include a slide block 23 slidably mounted on the lower end surface of the body 10. The vent holes 21 (including a first vent hole 211 and a second vent hole 212) are penetrated through the slide block 23. The slide block 23 is slidable, so that any one of the vent holes 21 is in communication with the air inlet 111.

After the vent hole 21 communicates with the air inlet 111, the airflow channel 11 in the body 10 communicates with the outside of the body 10 through the air inlet 111 and the vent hole, so that the air outside the body 10 can flow into the airflow channel 11 through the air inlet 111 and the vent hole 21.

In the present embodiments, since the sizes of the multiple vent holes 21 are provided differently, when different vent holes 21 are in corresponding communication with the air inlet 111 in a single one vent hole manner, the air intake amount at the air inlet 111 is also different. Therefore, when the different vent holes 21 are in communication with the air inlet 111 in a single one vent hole manner by driving the air regulating assembly 20 to move relative to the body 10, the air regulating function is realized.

It should be noted that, in order to ensure that the different vent holes 21 are in corresponding communication with the air inlet 111 in the single one vent hole manner to realize the air regulating function (the regulation of the air intake amount), the air inlet 111 needs to be greater than all the vent holes 21; or the air inlet 111 needs to be greater than or equal to a maximum one of the vent holes 21. The above-mentioned sentence “the vent hole 21 is in communication with the air inlet 111” means that the projection of the vent hole 21 on the air inlet 111 is completely located within the air inlet 111. That is, the vent hole 21 is completely in communication with the air inlet 111, and the air intake amount is determined by the size of the vent hole 21.

It should also be noted that the size of the vent hole 21 is constant, and the size of the vent hole 21 itself does not change when the air regulating assembly 20 is moved relative to the body 10. Therefore, the aerosol generating device 100 is configured to have multiple use modes, and each mode needs to be adapted to an accurate air intake amount to achieve an optimal experience effect. In this case, the multiple vent holes 21 can be correspondingly implemented in one use mode.

Specifically, at the time of production, the specific size (i.e., an opening area) of each vent hole 21 may be determined by calculation, test, or the like, so that the ventilation amount of each vent hole 21 corresponds to one use mode of the aerosol generating device 100.

When the air regulation is required, the user can drive the air regulating assembly 20 to move relative to the body 10, so that one of the vent holes 21 is in corresponding communication with the air inlet 111 of the airflow channel 11. The size of each of the vent holes 21 at the time of production corresponds to a certain use mode of the aerosol generating device 100, and the size of the vent hole 21 is unchanged during air regulation. So, the user can accurately regulate the air intake amount required in a certain use mode, thereby achieving accurate air regulation, and ensuring that the user can experience the best experience effect in a certain use mode of the aerosol generating device 100.

For example, optionally, in one embodiment, the aerosol generating device 100 is configured to have a first use mode and a second use mode. The multiple vent holes 21 include a first vent hole 211 and a second vent hole 212. The first vent hole 211 is larger than the second vent hole 212. The first vent hole 211 is configured to communicate with the air inlet 111 in the first use mode. The second vent hole 212 is configured to communicate with the air inlet 111 in the second use mode.

Specifically, in the present embodiment, the first use mode is a pulmonary suction mode, and the second use mode is a mouth suction mode. The pulmonary suction mode means that the user sucks the aerosol to enable the aerosol to enter into the lung; and the mouth suction mode means that the user sucks the aerosol to enable the aerosol to stay in the mouth. The ventilation amount required for the pulmonary suction mode is greater than the ventilation amount required for the mouth suction mode.

In the present embodiments, the size of the first vent hole 211 corresponds to the setting of the pulmonary suction mode, and the size of the second vent hole 212 corresponds to the setting of the mouth suction mode. The first vent hole 211 is larger than the second vent hole 212. The first vent hole 211 is used to communicate with the air inlet 111 in the pulmonary suction mode (that is, the first use mode), and the second vent hole 212 is used to communicate with the air inlet 111 in the mouth suction mode (that is, the second use mode). So, the user can accurately regulate the air intake amount required in the pulmonary suction mode or the mouth suction mode, so that the user can experience an optimal pulmonary suction effect or an optimal mouth suction effect.

It should be noted that, based on different types of the aerosol generating devices 100, the sizes of the airflow channels 11 in the bodies 10 are also different, and sizes of the first vent holes 211 and the second vent holes 212 are also different. In practical application, the sizes of both the first vent hole 211 and the second vent hole 212 can be determined by calculation, simulation, test, or the like. So, the ventilation amount of the first vent hole 211 corresponds accurately to the ventilation amount required for achieving the optimal effect in the pulmonary suction mode, and the ventilation amount of the second vent hole 212 corresponds accurately to the ventilation amount required for achieving the optimal effect in the mouth suction mode.

In addition, the air regulating assembly 20 may make the first vent hole 211 or the second vent hole 212 communicate with the air inlet 111 by rotating, sliding, etc. Alternatively, in one embodiment, as shown in FIG. 4, the air regulating assembly 20 is slidably mounted to the body 10, and the first vent hole 211 and the second vent hole 212 are provided at intervals along a sliding direction of the air regulating assembly 20. Specifically, the body 10 and the air inlet 111 are stationary, and the first vent hole 211 and the second vent hole 212 are provided at intervals along the sliding direction of the air regulating assembly 20, so, the first vent hole 211 and the second vent hole 212 are movable to positions in which the air regulating assembly 20 communicates with the air inlet 111 when the air regulating assembly 20 slides relative to the body 10. It will be appreciated that the air regulating assembly 20 enables the first vent hole 211 or the second vent hole 212 in corresponding communication with the air inlet 111 in a slidable manner. In this way, it is not only simple in structure, but also easy to disassemble and assemble, and thus easy to operate by the user, thereby improving the use experience.

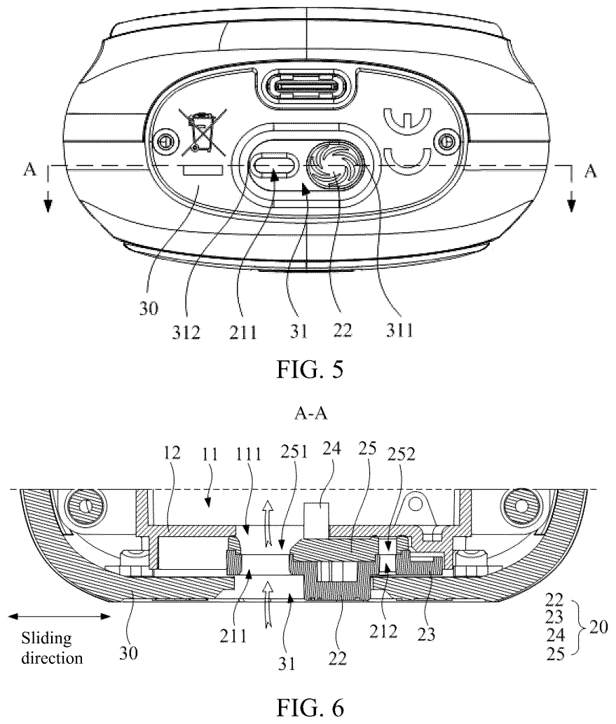

Alternatively, in one embodiment, as shown in FIGS. 5-10, the air regulating assembly 20 is configured to be linearly slidable with respect to the body 10 between a first position and a second position.

As shown in FIGS. 5 and 6, when the air regulating assembly 20 is in the first position, the first vent hole 211 is in full communication with the air inlet 111, and the second vent hole 212 is provided in a misalignment (i.e., not in communication at all) with the air inlet 111, so that the user can experience an optimal pulmonary suction effect.

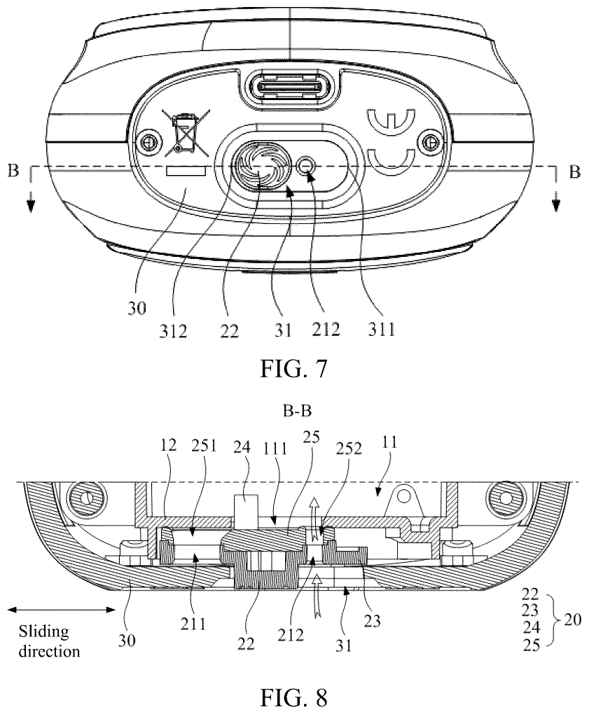

As shown in FIGS. 7 and 8, when the air regulating assembly 20 is in the second position, the second vent hole 212 is in full communication with the air inlet 111, and the first vent hole 211 is provided in a misalignment (i.e., not in communication at all) with the air inlet 111, so that the user can experience an optimal mouth suction effect.

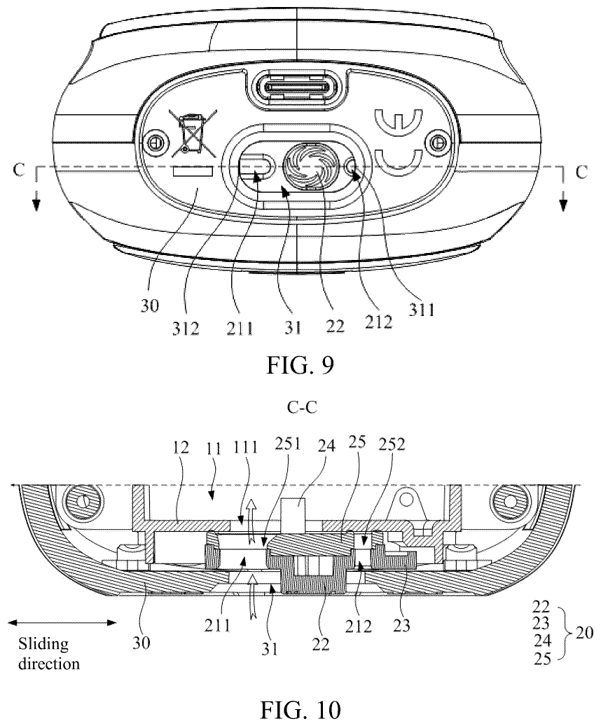

As shown in FIGS. 9 and 10, when the air regulating assembly 20 is positioned between the first position and the second position, the first vent hole 211 and/or the second vent hole 212 partially communicates with the air inlet 111. Specifically, in a state shown in FIG. 10, the air regulating assembly 20 is positioned between the first position and the second position, and the air regulating assembly 20 is closer to the first position. At this time, a portion of the first vent hole 211 communicates with the air inlet 111, and another portion of the first vent hole 211 does not communicate with the air inlet 111; and the second vent hole 212 does not communicate with the air inlet 111 at all. Thus, at this time, a ventilation area of the second vent hole 212 is smaller than a ventilation area of the air regulating assembly 20 at the first position, and the ventilation amount of the air inlet is less than the ventilation amount of the air regulating assembly 20 at the first position. When the air regulating assembly 20 is moved slowly toward the second position (i.e., the position shown in FIG. 8), the ventilation area of the second vent hole 212 is reduced gradually, and the ventilation amount of the air inlet is also gradually reduced.

It will be appreciated that when the air regulating assembly 20 gradually approaches the second position and has not yet reached the second position, the ventilation area of the first vent hole 211 gradually decreases, and a portion of the second vent hole 212 also starts to communicate with the air inlet 111. That is, the ventilation area of the second vent hole 212 gradually increases.

That is, when the air regulating assembly 20 is moved between the first position and the second position, the ventilation amount of the air inlet 111 is gradually increased or decreased, so that the stepless regulation of the air intake amount is realized.

Therefore, in the present application, the aerosol generating device 100 can realize the stepless regulation of the airflow amount on the basis of realizing precise regulation of the airflow amount, and thus the air regulation function is more comprehensive.

It should be noted that, in order to enable the air regulating assembly 20 to be more accurately positioned at the first position and the second position, a positioning structure, such as a positioning baffle or a positioning post, may be provided on the body 10. When the air regulating assembly 20 abuts against the positioning structure, it can be determined that the air regulating assembly 20 is at the first position or the second position.

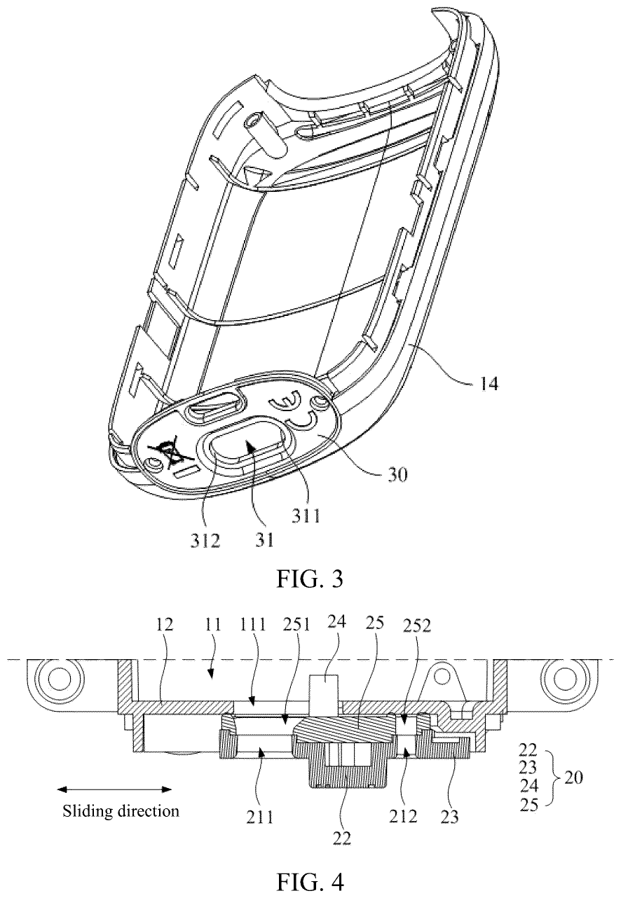

Alternatively, in another embodiment, referring to FIGS. 3, 5, and 7, the aerosol generating device 100 further includes a cover 30. The cover 30 is fixedly connected to the body 10. Specifically, the cover 30 is covered at the lower end of the body 10, and the cover 30 can be fixed to the body 10 by snapping, screwing, bonding, integral molding, or the like. Furthermore, in the present embodiment, the cover 30 is provided with a positioning through hole 31. The positioning through hole 31 includes a first positioning end 311 and a second positioning end 312 opposite to each other in the sliding direction of the air regulating assembly 20.

As shown in FIG. 6 or FIG. 8, the air regulating assembly 20 is slidably mounted between the body 10 and the cover 30, and the air regulating assembly 20 is provided with a toggle button 22 penetrating through and disposing in the positioning through hole 31. As shown in FIG. 5, when the air regulating assembly 20 is in the first position, the toggle button 22 abuts against the first positioning end 311. When the air regulating assembly 20 is in the second position, the toggle button 22 abuts against the second positioning end 312, as shown in FIG. 7.

Specifically, in use, the user can manually push the toggle button 22 so that the air regulating assembly 20 slides relative to the body 10. When the toggle button 22 is pushed to the first positioning end 311 and the toggle button 22 abuts against the first positioning end 311, it can be determined that the air regulating assembly 20 is in the first position. When the toggle button 22 is pushed to the second positioning end 312, and the toggle button 22 abuts against the second positioning end 312, it can be determined that the air regulating assembly 20 is in the second position.

It will be appreciated that, in the present embodiment, the structure for positioning the air regulating assembly 20 is provided on the cover 30, so it can conveniently determine whether the air regulating assembly 20 is in the first position or the second position. The protection of the air regulating assembly 20 can be realized by the cover 30. In this way, the occurrence of collision between the external objects and the air regulating assembly 20 may be avoided to further cause the air regulating assembly 20 to fall off.

It should be noted here that, the specific position of the positioning through hole 31 may be flexibly selected as desired. For example, alternatively, in one embodiment, as shown in FIG. 6 or FIG. 8, the positioning through hole 31 is disposed opposite the air inlet 111, and the toggle button 22 is disposed between the first vent hole 211 and the second vent hole 212, as well as penetrated through and disposed in the positioning through hole 31. As shown in FIG. 6, when the air regulating assembly 20 is in the first position, the first vent hole 211 also communicates with the positioning through hole 31. At this time, the airflow channel 11 communicates with the external environment through the air inlet 111, the first vent hole 211, and the positioning through hole 31. As shown in FIG. 8, when the air regulating assembly 20 is in the second position, the second vent hole 212 also communicates with the positioning through hole 31. At this time, the airflow channel 11 communicates with the external environment through the air inlet 111, the second vent hole 212, and the positioning through hole 31.

It will be appreciated that, in the present embodiment, it is possible to make the structure of the aerosol generating device 100 more compact by arranging the positioning hole 31 and the air inlet 111 opposite each other, thereby facilitating the miniaturization design of the aerosol generating device 100.

Of course, in other embodiments, the positioning through hole 31 may not be disposed opposite the air inlet 111. For example, a portion of the cover 30 corresponding to the air inlet 111 may be arranged with a vent through hole. The positioning through hole 31 is located at a side of the vent through hole, and the toggle button 22 is penetrated through and disposed in the positioning through hole 31.

Alternatively, in one embodiment, referring to FIGS. 2 and 4, the body 10 includes a rack 12 having an air inlet 111. The air regulating assembly 20 includes a slide block 23 through which a first vent hole 211 and a second vent hole 212 are penetrated. A snap fitter 24 is provided on the slide block 23. The snap fitter 24 penetrates through the air inlet 111 and is slidably snap-engaged with the rack 12.

Specifically, in the present embodiment, the rack 12 is located at the lower end of the body 10. The rack is used to support a power supply assembly (including a battery 17, a control board, and the like). The air inlet 111 is penetrated through a plate of the rack 12 which faces towards the cover 30. The air regulating assembly 20 includes the slide block 23 having an overall shape approximately rectangular parallelepiped. A first vent hole 211 and a second vent hole 212 are penetrated through the slide block 23. The slide block 23 is also provided with a snap fitter 24, which can be integrally formed with the slide block 23. The number of snap fitters 24 may be multiple. For example, two snap fitters 24 can be provided. The two snap fitters 24 are slidably snapped to the rack 12 after passing through the air inlet 111. In this way, not only the connection of the air regulating assembly 20 to the body 10 can be realized, but also the air regulating assembly 20 can be slid relative to the body 10. So, the structure is simple, and the production is also facilitative.

Alternatively, in one embodiment, as shown in FIGS. 2 and 4, the air regulating assembly 20 further includes a sealing block 25 mounted to the slide block 23. The sealing block 25 is slid along with the slide of the slide block 23. The sealing block 25 is disposed between the slide block 23 and the rack 12. So, a clearance between the slide block 23 and the rack 12 can be sealed. In the present embodiment, a first sealing hole 251 and a second sealing hole 252 are further penetrated through the sealing block 25. The first sealing hole 251 is in corresponding communication with the first vent hole 211, and the second sealing hole 252 is in corresponding communication with the second vent hole 212.

It will be appreciated that the sealing block 25 is compressed between the slide block 23 and the rack 12, the sealing block 25 has only the first sealing hole 251 and the second sealing hole 252 for ventilation, and the first sealing hole 251 and the second sealing hole 252 are in corresponding communication with the first vent hole 211 and the second vent hole 212, respectively. So, it is possible to ensure that the airflow can only flow into the air inlet 111 through the first vent hole 211 or the second vent hole 212, so that it can avoid the airflow from other positions into the air inlet 111, and the accuracy of the airflow amount is ensured, thereby achieving the accurate air regulation.

Alternatively, in one embodiment, as shown in FIG. 1, the airflow channel 11 is further provided with a plurality of heating elements 13. The aerosol generating device 100 further includes a control board (not shown) and a control switch (not shown). The plurality of heating elements 13 and the control switch are electrically connected to the control board, respectively. The control switch is used for controlling the first number of heating elements 13 to be powered on to generate heat in the first use mode. The control switch is also used for controlling the second number of heating elements 13 to be powered on to generate heat in the second use mode. The first number is greater than the second number.

Specifically, in the present embodiment, as previously described, the atomizing assembly is provided in the airflow channel 11. The atomizing assembly includes heating elements 13. In the present embodiment, the number of the heating elements 13 are multiple, and may be two, three, four, five, six, and the like.

The multiple heating elements 13 are provided in the same manner, and the multiple heating elements 13 are respectively electrically connected to the control board. The aerosol generating device 100 further includes the control switch. The control switch is electrically connected to the control board. The control switch is used to control whether the control board supplies power to the corresponding heating element 13. That is, the control switch is used to control whether each heating element 13 is powered on to generate heat.

Specifically, in the present embodiment, in the first use mode (i.e., in the pulmonary suction mode), the control switch is used to control the first number of heating elements 13 to be powered on to generate heat. In the second use mode (i.e., in the mouth suction mode), the control switch controls the second number of heating elements 13 to be powered on to generate heat.

The airflow amount required for the pulmonary suction mode is larger than the airflow amount required for the mouth suction mode, more atomized liquid is required when the airflow amount is larger, and only less atomized liquid is required when the airflow amount is smaller. Therefore, in the present embodiment, in a case where the first number is greater than the second number, in the pulmonary suction mode, the control switch controls the larger number of heating elements 13 to be powered on to generate heat to match the larger airflow amount, so as to avoid overlight mouthfeel; and in the mouth suction mode, the control switch controls the smaller number of heating elements 13 to be powered on to generate heat to match a smaller airflow amount, so as to avoid the overly strong of mouthfeel.

For example, as shown in FIG. 1, the number of the heating elements 13 may be four. In the pulmonary suction mode, the control switch may control the four heating elements 13 to be powered on to generate heat, and in the mouth suction mode, the control switch may control the two heating elements 13 to be powered on to generate heat.

It should be noted that the control switch may be a knob, a button, a toggle button, or the like exposed to the surface of the body 10; or may be an sensing switch. Different numbers of the heating elements 13 may be controlled to be powered on to generate heat by sensing the position of the air regulating assembly 20 via the sensing switch.

It should also be noted that when the user toggles the air regulating assembly 20 between the first position and the second position to achieve the stepless air regulation, the user may control any number of the heating elements 13 to be powered on to generate heat according the needs.

Alternatively, in one embodiment, as shown in FIG. 1, the airflow channel 11 includes a first sub-channel 112 and a second sub-channel 113. The first sub-channel 112 and the second sub-channel 113 respectively communicates with the air inlet 111. The first sub-channel 112 and the second sub-channel 113 are respectively provided with heating element(s) 13. Specifically, the first sub-channel 112 and the second sub-channel 113 may be each provided with one heating element 13 or multiple heating elements 13.

In the present embodiment, the control switch is configured to control the heating elements 13 in both the first sub-channel 112 and the second sub-channel 113 to be powered on to generate heat in the first use mode. The control switch is also used to control the heating element(s) 13 in the first sub-channel 112 and/or the second sub-channel 113 to be powered on to generate heat in the second use mode.

Specifically, in the present embodiment, two heating elements 13 are provided in each of the first sub-channel 112 and the second sub-channel 113. In the first use mode (i.e., the pulmonary suction mode), the control switch controls the heating elements 13 in both the first sub-channel 112 and the second sub-channel 113 to be powered on to generate heat. That is, the four heating elements 13 are all powered on to generate heat.

In the second use mode (i.e., the mouth suction mode), the control switch may control only one heating element or two heating elements 13 in the first sub-channel 112 to be powered on to generate heat, and control the two heating elements 13 in the second sub-channel 113 to not be powered on to generate heat. Alternatively, the control switch may control only one heating element 13 or the two heating elements 13 in the second sub-channel 113 to be powered on to generate heat, and control the two heating elements 13 in the first sub-channel 112 not to powered on to generate heat. Alternatively, the control switch may also control one heating element 13 in each of the first sub-channel 112 and the second sub-channel 113 to be powered on to generate heat, i.e., one heating element 13 in each sub-channel is powered on to generate heat.

It should be noted here that when the user toggles the air regulating assembly 20 between the first position and the second position to achieve the stepless air regulation, the user may control the three heating elements 13 to be powered on to generate heat by the control switch. Specifically, two heating elements 13 in the first sub-channel 112 and one heating element 13 in the second sub-channel 113 may be powered on to generate heat; or one heating element 13 in the first sub-channel 112 and two heating elements 13 in the second sub-channel 113 may be powered on to generate heat.

Alternatively, in another embodiment, as shown in FIG. 1, the airflow channel 11 includes a first sub-channel 112 and a second sub-channel 113. That is, the aerosol generating device 100 in the present embodiment is of a dual-air-passage structure. The first sub-channel 112 and the second sub-channel 113 respectively communicate with the air inlet 111, and the first sub-channel 112 and the second sub-channel 113 are respectively provided with the same number of heating elements 13. Specifically, four heating elements 13 are provided in total. In this case, two heating elements 13 are provided in the first sub-channel 112, and other two heating elements 13 are provided in the second sub-channel 113. The first sub-channel 112 has the same number of heating elements 13 as the second sub-channel 113.

In the present embodiment, the control switch is used to control the same number of heating elements 13 in each of the first sub-channel 112 and the second sub-channel 113 to be powered on to generate heat in the first use mode. The control switch is also used to control the same number of heating elements 13 in each of the first sub-channel 112 and the second sub-channel 113 to be powered on to generate heat in the second use mode.

Specifically, above-mentioned four heating elements 13 are provided as an example. As shown in the foregoing, in the first use mode (i.e., the pulmonary suction mode), the control switch needs to control the four heating elements 13 to be powered on to generate heat. At this time, the control switch controls all of the two heating elements 13 in the first sub-channel 112 to be powered on to generate heat, and simultaneously controls all of the two heating elements 13 in the second sub-channel 113 to be powered on to generate heat.

In the second use mode (i.e., the mouth suction mode), the control switch needs to control the two heating elements 13 to be powered on to generate heat. At this time, the control switch controls one heating element 13 in the first sub-channel 112 to be powered on to generate heat, and controls one heating element 13 in the second sub-channel 113 to be powered on to generate heat.

It will be appreciated that, in the present embodiment, the same number of heating elements 13 in each of the first sub-channel 112 and the second sub-channel 113 are controlled to be powered on to generate heat by the control switch regardless of the mode. So, it ensures that the aerosol concentration in the two sub-channels is more uniform, which avoids the aerosol concentration difference between the two sub-channels to be too large so as to affect the mouthfeel.

In the above-mentioned embodiments, the description of each embodiment has its own emphasis, and parts not described in detail in a certain embodiment may be referred to the related description of other embodiments. In the description of this application, the terms “first” and “second” are used for descriptive purposes only and are not to be construed as indicating or implying relative importance or implying the number of indicated technical features. Therefore, the features defined as “first” or “second”may explicitly or implicitly include one or more features.

The aerosol generating device provided in the embodiments of the present application is introduced in detail above. The principles and the implementation methods of the present application are described in detail using specific examples. The description of the above embodiments is only used to help understand the method and the core idea of the present application. At the same time, for those skilled in the art, according to the idea of the present application, there may be changes in the specific implementation method and the application scope. In summary, the content of this specification should not be understood as limiting the present application.

What is claimed is:

1. An aerosol generating device comprising:
a body in which an airflow channel is provided, wherein the airflow channel comprises an air inlet; and
an air regulating assembly movably mounted at the air inlet, wherein the air regulating assembly is provided with a plurality of vent holes, the plurality of vent holes are different in size, the air regulating assembly is capable of moving relative to the body such that one of the plurality of vent holes communicates with the air inlet;
and the airflow channel is configured to communicate with an exterior of the body through the vent hole and the air inlet when the vent hole communicates with the air inlet.

2. The aerosol generating device according to claim 1, wherein the aerosol generating device is configured to have a first use mode and a second use mode, the plurality of vent holes comprises a first vent hole and a second vent hole, and the first vent hole is larger than the second vent hole;
the first vent hole is configured to communicate with the air inlet in the first use mode, and the second vent hole is configured to communicate with the air inlet in the second use mode.

3. The aerosol generating device according to claim 2, wherein the air regulating assembly is slidablly mounted to the body, and the first vent hole and the second vent hole are spaced apart in a sliding direction of the air regulating assembly.

4. The aerosol generating device according to claim 3, wherein the air regulating assembly is configured to be slidable relative to the body between a first position and a second position;
when the air regulating assembly is located in the first position, the first vent hole is in communication with the air inlet, and the second vent hole is misaligned with the air inlet;
when the air regulating assembly is located in the second position, the second vent hole is in communication with the air inlet, and the first vent hole is misaligned with the air inlet;
the first vent hole and/or the second vent hole is partially in communication with the air inlet when the air regulating assembly is located between the first position and the second position.

5. The aerosol generating device according to claim 4, wherein the aerosol generating device further comprises a cover, the cover is fixedly connected to the body, the cover is provided with a positioning through hole, and the positioning through hole comprises a first positioning end and a second positioning end which are opposite to each other in the sliding direction of the air regulating assembly;
the air regulating assembly is slidably mounted between the body and the cover, the air regulating assembly is provided with a toggle button, and the toggle button passes through the positioning through hole;
the toggle button abuts against the first positioning end when the air regulating assembly is in the first position;
the toggle button abuts against the second positioning end when the air regulating assembly is in the second position.

6. The aerosol generating device according to claim 5, wherein the positioning through hole is disposed opposite to the air inlet, and the toggle button is disposed between the first vent hole and the second vent hole and penetrate through the positioning through hole;
the first vent further communicates with the positioning through hole when the air regulating assembly is in the first position; and the second vent further communicates with the positioning through hole when the air regulating assembly is in the second position.

7. The aerosol generating device according to claim 5, wherein the toggle button is protruded from the first vent hole and the second vent hole in a direction away from the air inlet.

8. The aerosol generating device according to claim 5, wherein a portion of the cover corresponding to the air inlet is arranged with a vent through hole, the positioning through hole is located at a side of the vent through hole, and the toggle button is penetrated through and disposed in the positioning through hole.

9. The aerosol generating device according to claim 3, wherein the body comprises a rack in which the air inlet is provided;
the air regulating assembly comprises a slide block, the slide block is provided with the first vent hole and the second vent hole, and the slide block further provided with one or more snap fitters, and the one or more snap fitters penetrate through the air inlet and are slidably connected with the rack.

10. The aerosol generating device according to claim 9, wherein the rack is located at a lower end of the body, and the air inlet is penetrated through a plate of the rack which faces towards the cover.

11. The aerosol generating device according to claim 9, wherein the snap fitter and the slide block are integrally formed.

12. The aerosol generating device according to claim 9, wherein the air regulating assembly further comprises a sealing block mounted on the slide block, and the sealing block is disposed between the slide block and the rack;
the sealing block is further provided with a first sealing hole and a second sealing hole, wherein the first sealing hole is in corresponding communication with the first vent hole, and the second sealing hole is in corresponding communication with the second vent hole.

13. The aerosol generating device according to claim 2, wherein a plurality of heating elements are further provided in the airflow channel, the aerosol generating device further comprises a control board and a control switch, and the plurality of heating elements and the control switch are respectively electrically connected to the control board;
the control switch is configured to control a first number of heating elements of the plurality of heating elements to be powered on to generate heat in the first use mode; and further configured to control a second number of heating elements of the plurality of heating elements to be powered on to generate heat in the second use mode, wherein the first number is greater than the second number.

14. The aerosol generating device according to claim 13, wherein the airflow channel comprises a first sub-channel and a second sub-channel, the first sub-channel and the second sub-channel are each communicate with the air inlet, and the first sub-channel and the second sub-channel are each provided with at least one of the plurality of heating elements;
the control switch is configured to control the at least heating element in each of the first sub-channel and the second sub-channel to be powered on to generate heat in the first use mode; and the control switch is further configured to control the at least one heating element in each of the first sub-channel and/or the second sub-channel to be powered on to generate heat in the second use mode.

15. The aerosol generating device according to claim 14, wherein the first sub-channel is provided with same number of the plurality of heating elements as the second sub-channel.

16. The aerosol generating device according to claim 1, wherein the body comprises a housing and an air guide assembly, the air guide assembly comprises an air guide tube mounted in the housing, and a part of the airflow channel is provided in the air guide tube.

17. The aerosol generating device according to claim 16, wherein the air channel comprises an air outlet, the housing comprises a suction nozzle, the air inlet is provided at a portion of the airflow channel which is at a lower end of the body, and the air outlet is provided at a portion of the airflow channel which is at the suction nozzle.

18. The aerosol generating device according to claim 1, wherein the air channel comprises an air outlet located a lower end of a circumferential side surface of the body, the air regulating assembly comprises an air regulating ring, and the plurality of vent holes penetrate through the air regulating ring.

19. The aerosol generating device according to claim 1, wherein the air channel comprises an air outlet located a lower end surface of the body, the air regulating assembly comprises an air regulating rotation disc mounted on a lower end surface of the body, and the plurality of vent holes penetrate through the air regulating rotation disc.

20. The aerosol generating device according to claim 1, wherein a size of the air inlet is greater than sizes of the plurality of vent holes.
